(19) United States
(12) Patent Application Publication
(10) Pub. No.: US 2005/0268089 A1
(43) Pub. Date: Dec. 1, 2005

(54) Printing system and method that support security function

(75) Inventors: Jong-wook Kim, Suwon-si (KR); Yong-jo Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/108,137

(22) Filed: Apr. 18, 2005

(30) Foreign Application Priority Data
May 25, 2004 (KR) 2004-37258

(51) Int. Cl. H04L 9/00; H04L 9/32; G06F 11/30; G06F 12/14

(52) U.S. Cl. 713/153; 713/189

(57) ABSTRACT

Provided are a printing system and printing method, which enable a host to set a security function in a document and then to transmit the document to a printer and enable the printer to print only a document whose security function is cancelled. The printing system comprises a host, which encrypts data that is to be printed by using encryption keys when a print command is received; a movable storage medium, which is connected to the host and stores the encryption keys; and a printer, which is connected to the movable storage medium, decrypts the encrypted data transmitted from the host by using the encryption keys stored in the movable storage medium, and then prints the decrypted data.

### CROSS-REFERENCE TO RELATED APPLICATION

This application claims the benefit under 35 U.S.C. §119(a) of Korean Patent Application No. 2004-37258, filed on May 25, 2004, in the Korean Intellectual Property Office, the entire disclosure of which is hereby incorporated by reference.

### BACKGROUND OF THE INVENTION

1. Field of the Invention

The present invention relates to a printing system and method, which print a document. More particularly, the present application relates to a printing system and method, which enable a host to set a security function in a document and then to transmit the document to a printer and enable the printer to print only a document whose security function is authenticated.

2. Description of the Related Art

In recent years, increased public attention has been drawn to the security of information. In general, people who work for a government and public office, a large enterprise, or a research institute more often than not share a printer via a network and print documents with the shared printer. However, such a printing system may cause an authorized disclosure of confidential information during the printing of confidential documents.

FIG. 1 is a block diagram of a conventional printing system that supports a security function. Referring to FIG. 1, the conventional printing system includes a host 100 and a printer 110. The host 100 comprises a data processing unit 100-1, which formats data to be transmitted by processing data to be printed and authentication information, a transmission unit 100-2, which transmits the data to be transmitted to the printer 110, and a control unit 100-3, which receives the data to be printed from an application unit (not shown) and controls the data processing unit 100-1 and the transmission unit 100-2. The printer 110 comprises a receipt unit 110-1, which receives the data transmitted from the host 100, an authentication processing unit 110-2, which authenticates the data to be printed, contained in the data, by comparing a password contained in the, with a password previously stored, a printing unit 110-3, which receives a print command and prints the data to be printed in response to the print command, and a control unit 110-4, which controls the receipt unit 110-1, the authentication processing unit 110-2, and the printing unit 110-3.

The data processing unit 100-1 formats the data to be transmitted by attaching an ID and a password to the data to be printed. The control unit 100-3 controls the data processing unit 100-1 to transmit the data to be transmitted to the transmission unit 100-2. Thereafter, the transmission unit 100-2 transmits the data to be transmitted to the printer 110. The receipt unit 110-1 receives the data, analyzes the data, and transmits the ID and password of the data to the authentication processing unit 110-2. The authentication processing unit 110-2 determines whether to authenticate the data to be printed based on a result of comparing the password attached to the data to be printed with the previously stored password. If the data to be printed is successfully authenticated, the control unit 110-4 controls the printing unit 110-3 to print the data to be printed.

In the conventional printing system, however, confidential documents may be intercepted by an unauthorized user in the process of being transmitted over a network. In addition, once the confidential documents are printed, they become accessible by almost everyone. In the case where a storage device of the conventional printing system accidentally falls into an unauthorized person's possession, the unauthorized person can have unlimited access to all information stored in the storage device.

Accordingly, there is a need for an improved secure printing method to prevent the interception of confidential documents during transmission over a network by unauthorized users.

### SUMMARY OF THE INVENTION

The present invention provides a printing system and method, which encrypt a document by using encryption keys, store the encryption keys in a movable storage medium while transmitting the encrypted document to a printer, decrypt the encrypted document by using the encryption keys stored in the movable storage medium, and print the decrypted document.

The present invention also provides a printing system and method, which encrypt a document by using encryption keys, transmit the encryption keys to a predetermined server while transmitting the encrypted document to a printer, and decrypt the encrypted document and print the decrypted document if the encryption keys input by a user match the encryption key stored in the predetermined server.

According to an aspect of the present invention, there is provided a printing system that supports a security function. The printing system comprises a host, which encrypts data that is to be printed by using encryption keys when a print command is received; a movable storage medium, which is connected to the host and stores the encryption keys; and a printer, which is connected to the movable storage medium, decrypts the encrypted data transmitted from the host by using the encryption keys stored in the movable storage medium, and then prints the decrypted data.

The encryption keys preferably comprise a print operation ID and a unique key generated by the host in response to the receipt of the print command.

The host can include a key generation unit, which generates the print operation ID and the unique key in response to the receipt of the print command; an encryption unit, which encrypts the data by using the print operation ID and the unique key; and a transmission unit, which transmits the encrypted data to the printer and transmits the print operation ID and the unique key to the movable storage medium.

The printer may include a searching unit, which receives the print operation ID and the unique key from the movable storage medium and searches various encrypted data that have been received from the host for data corresponding to the print operation ID; a decryption unit, which decrypts the data retrieved by the searching unit by using the unique key received by the searching unit; and a conversion and output unit, which converts the decrypted data into an image and then outputs the image.

The printer may further include a storage unit, which stores the various encrypted data that have been received from the host.

According to another aspect of the present invention, there is provided a printing method that supports a security function. The printing method involves (a) encrypting data that is to be printed by using encryption keys when a print command is received; (b) transmitting the encrypted data to a printer and transmitting the encryption keys to a movable storage medium; and (c) decrypting the encrypted data by using the encryption keys stored in the movable storage medium and then printing the decrypted data.

The encryption keys may be a print operation ID and a unique key generated by the host in response to the receipt of the print command.

Step (a) of an embodiment of the printing method may include step (a-1) generating the print operation ID and the unique key when the print command is received; and step (a-2) encrypting the data by using the print operation ID and the unique key.

Step (c) of an embodiment of the printing method may include step (c-1) searching various encrypted data that have been received from the host for data corresponding to the print operation ID stored in the movable storage medium; step (c-2) decrypting the retrieved data by using the unique key stored in the movable storage medium; and step (c-3) converting the decrypted data into an image and then printing the image.

According to another aspect of the present invention, there is provided a printing system that supports a security function. The printing system comprises a host, which encrypts data that is to be printed by using a print operation ID and a unique key when a print command is received; a server, which receives the print operation ID and the unique key from the host via a network and then stores and outputs the print operation ID and the unique key; and a printer, which searches various encrypted data that have been received from the host for data corresponding to a print operation ID input by a user, issues a request for a unique key for the searched data to the server, decrypts the searched data with the unique key received from the server, and then outputs the decrypted data.

The host may include a key generation unit, which generates the print operation ID and the unique key in response to the receipt of the print command; an encryption unit, which encrypts the data by using the print operation ID and the unique key and transmits the print operation ID and the unique key to the server; a display unit, which displays the print operation ID; and a transmission unit, which transmits the encrypted data to the printer.

The printer may include an input unit, which allows the user to input the same print operation ID as the print operation ID displayed by the display unit; a searching unit, which searches the various encrypted data that have been received from the host for the data corresponding to the print operation ID, issues a request for the unique key for the searched data to the server, and receives the unique key for the searched data; a decryption unit, which decrypts the data searched by the searching unit by using the unique key received by the searching unit; and a conversion and output unit, which converts the decrypted data into an image and then outputs the image.

The printer may further include a storage unit, which stores the various encrypted data that have been received from the host.

According to another aspect of the present invention, there is provided a printing method that supports a security function. The printing method involves step (a) encrypting data that is to be printed by using a print operation ID and a unique key when a print command is received; step (b) transmitting the encrypted data to the printer and transmitting the print operation ID and the unique key to a server via a network; and step (c) decrypting data corresponding to an input print operation ID by using the unique key stored in the server and then outputting the decrypted data.

Step (a) of an embodiment of the printing method may involve step (a-1) generating the print operation ID and the unique key in response to the receipt of the print command; step (a-2) encrypting the data by using the print operation ID and the unique key; and step (a-3) displaying the print operation ID.

Step (c) of an embodiment of the printing method may involve step (c-1) allowing the user to input the same print operation ID as the print operation ID displayed in step (a-3); step (c-2) searching the various encrypted data that have been received from the host for the data corresponding to the print operation ID; step (c-3) issuing a request for the unique key for the searched data to the server and receiving the unique key for the searched data; step (c-4) decrypting the data searched by the searching unit by using the unique key received in step (c-3); and step (c-5) converting the decrypted data into an image and then outputting the image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional printing system that supports a security function;

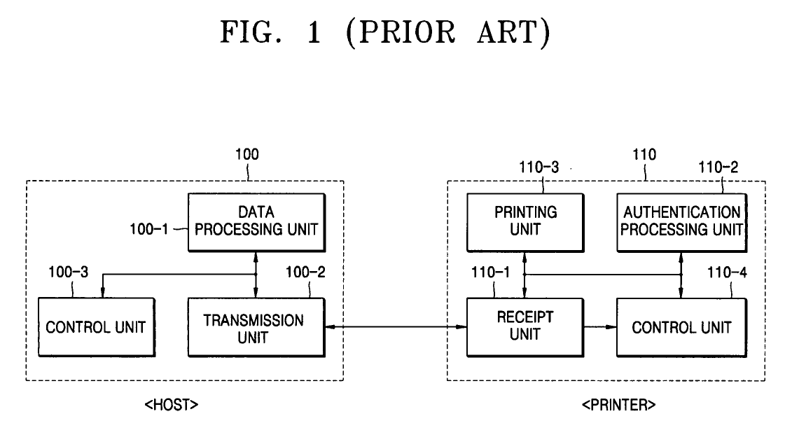

FIG. 2 is a block diagram of a printing system that supports a security function according to an exemplary embodiment of the present invention;

FIG. 3 is a flowchart of a printing method that supports a security function according to an embodiment of the present invention;

FIG. 4 is a block diagram of a printing system that supports a security function according to another embodiment of the present invention; and

FIG. 5 is a flowchart of a printing method that supports a security function according to another embodiment of the present invention.

Throughout the drawing, it should be understood that like reference numbers refer to like features, structures, and elements.

### DETAILED DESCRIPTION OF EXEMPLARY EMBODIMENTS

The present invention will now be described more fully with reference to the accompanying drawings, in which exemplary embodiments of the invention are shown.

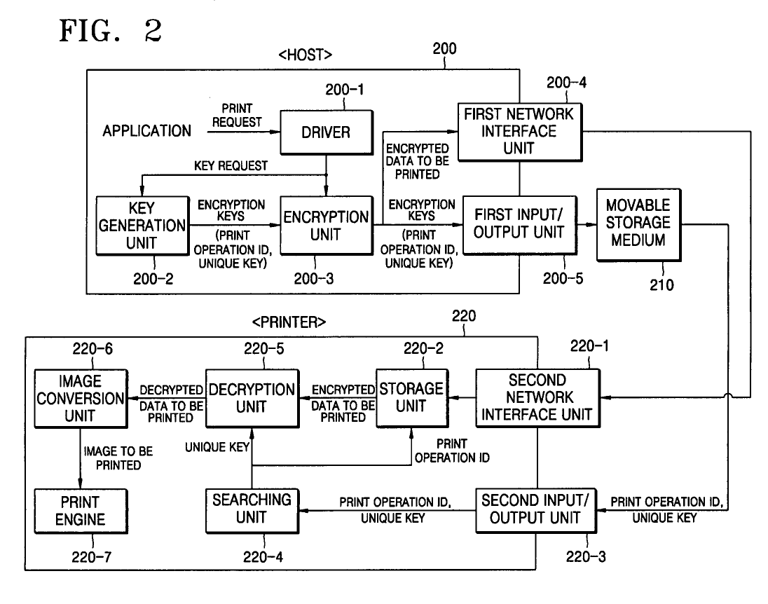

FIG. 2 is a block diagram of a printing system that supports a security function according to an embodiment of the present invention. Referring to FIG. 2, the printing system comprises a host 200, a movable storage medium 210, and a printer 220. The host 200 comprises a driver 200-1, a key generation unit 200-2, an encryption unit 200-3, a first network interface unit 200-4, and a first input/output unit 200-5. The printer 220 comprises a second network interface unit 220-1, a storage unit 220-2, a second input/output unit 220-3, a searching unit 220-4, a decryption unit 220-5, an image conversion unit 220-6, and a print engine 220-7.

When the driver 200-1 receives a print command from a user while executing an application program, it issues a command to generate a print operation ID and a unique key request, which is used to create encryption keys, to the key generation unit 200-2 and transmits data, which is to be printed, to the encryption unit 200-3.

The key generation unit 200-2 generates the print operation ID and the unique key in response to the receipt of the request command issued by the driver 200-1. The print operation ID is an ID of a print operation, which is generated in response to the receipt of the print command, and the unique key is an arbitrary set of characters.

The encryption unit 200-3 encrypts the data by using the print operation ID and the unique key generated by the key generation unit 200-2.

The first network interface unit 200-4 transmits the encrypted data to the printer 200.

The first input/output unit 200-5 transmits the print operation ID and the unique key to the movable storage medium 210.

The first network interface unit 200-4 and the first input/output unit 200-5 will be referred to as a transmission unit.

A user who possesses the movable storage medium 210 takes it to the printer 220 and then connects the movable storage medium 210 to the printer 220. The movable storage medium 210 may be a USB memory, an optical disk, a mini disk, a typical floppy disk or other suitable memory storage device.

The second network interface unit 220-1 of the printer 220 receives the encrypted data from the first network interface unit 200-4.

The storage unit 220-2 stores the encrypted data received by the second network interface unit 220-1. The storage unit 220-2 stores various encrypted data and the respective print operation IDs as files.

The second input/output unit 220-3 receives the print operation ID and the unique key from the movable storage medium 210 connected to the printer 220.

The searching unit 220-4 receives the print operation ID and the unique key from the second input/output unit 220-3 and searches the storage unit 220-2 for data which is a match for the received print operation ID.

The decryption unit 220-5 receives the data searched for by the searching unit 220-4 and decrypts the searched data by using the unique key transmitted from the searching unit 220-4.

The image conversion unit 220-6 converts the decrypted data transmitted from the decryption unit 220-5 into an image and transmits the image to the print engine 220-7.

The print engine 220-7 outputs the image received from the image conversion unit 220-6.

The image conversion unit 220-6 and the print engine 220-7 will be referred to as a conversion and output unit.

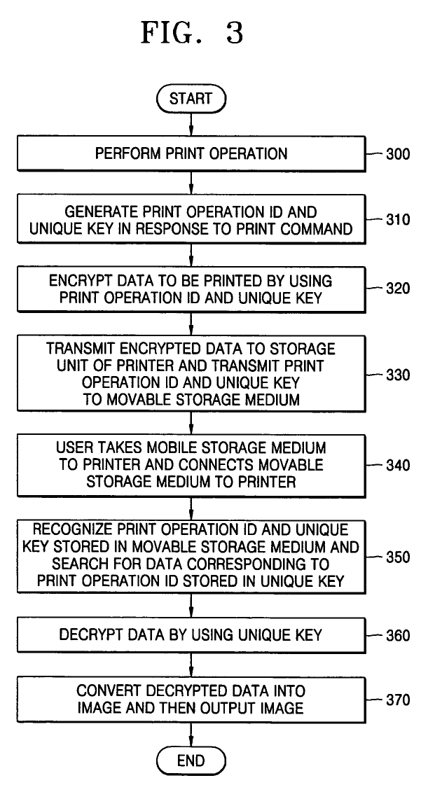

FIG. 3 is a flowchart of a printing method that supports a security function according to an embodiment of the present invention. Referring to FIGS. 2 and 3, in operation 300, a print operation is performed when the host 200 receives a print command from a user while executing an application program.

When the host 200 receives the print command from the user, the key generation unit 200-2 of the host 200 generates a print operation ID and a unique key as encryption keys in operation 310. Here, the print operation ID is an ID of a print operation, which is generated in response of the receipt of the print command, and the unique key is preferably an arbitrary set of characters.

In operation 320, the encryption unit 200-3 encrypts data by using the print operation ID and the unique key generated by the key generation unit 200-2.

In operation 330, the encrypted data is transmitted to the storage unit 220-2 of the printer 220 via the first network interface unit 200-4 and then stored therein, and the print operation ID and the unique key are transmitted to the movable storage medium 210 via the first input/output unit 200-5 and then stored therein.

Thereafter, in operation 340, the user who possesses the movable storage medium 210 takes the mobile storage medium 210 to the printer 220 and then connects the movable storage medium 210 to the printer 220.

In operation 350, the searching unit 220-4 receives the print operation ID and the unique key from the second input/output unit 220-3, which has recognized the print operation ID and unique key stored in the movable storage medium, and searches the storage unit 220-2 for data which is a match for the received print operation ID.

In operation 360, the decryption unit 220-5 receives the data searched for by the searching unit 220-4 and decrypts the searched data by using the unique key transmitted from the searching unit 220-4.

In operation 370, the image conversion unit 220-6 converts the decrypted data transmitted from the decryption unit 220-5 into an image and transmits the image to the print engine 220-7, and the print engine 220-7 outputs the image received from the image conversion unit 220-6.

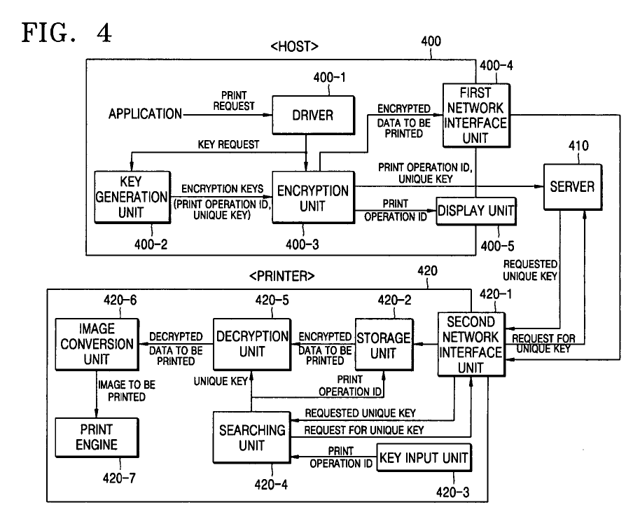

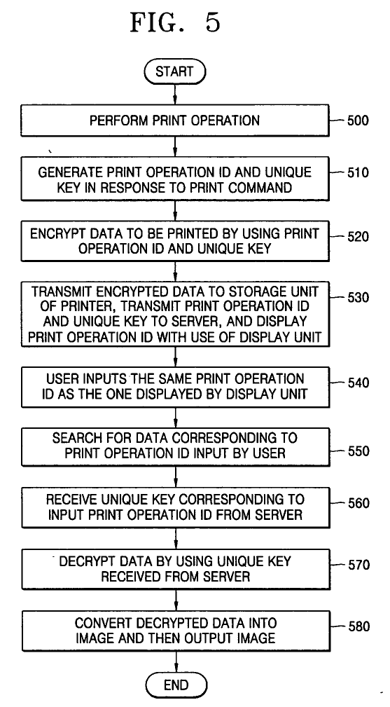

A printing system and method that supports a security function according to another embodiment of the present invention will now be described in greater detail with reference to FIGS. 4 and 5. The printing system and method will now be described with reference to FIGS. 4 and 5, which are different from the printing system and method of FIGS. 2 and 3 in that a server 410 is used instead of the movable storage medium 210, a print operation ID is displayed by a display unit 400-5 of a host 400, and a user inputs the displayed print operation ID by using a key input unit 420-4 of a printer 420.

FIG. 4 is a block diagram of a printing system that supports a security function according to another exemplary embodiment of the present invention. Referring to FIG. 4, the printing system comprises a host 400, the server 410, and the printer 420. The host 400 comprises a driver 400-1, a key generation unit 400-2, an encryption unit 400-3, a first network interface unit 400-4, and the display unit 400-5. The printer 420 comprises a second network interface unit 420-1, a storage unit 420-2, the key input unit 420-3, a searching unit 420-4, a decryption unit 420-5, an image conversion unit 420-6, and a print engine 420-7.

When the driver 400-1 receives a print command from a user while executing an application program, it issues a command to generate a print operation ID and a unique key as encryption keys to the key generation unit 400-2 and transmits data, which is to be printed, to the encryption unit 400-3.

The key generation unit 400-2 generates the print operation ID and the unique key in response to the receipt of the command issued by the driver 400-1. The print operation ID is an ID of a print operation, which is generated in response to the receipt of the print command, and the unique key is an arbitrary set of characters.

The encryption unit 400-3 encrypts the data by using the print operation ID and the unique key generated by the key generation unit 200-2 and then transmits the print operation ID and the unique key to the server 410.

The server 410 is connected to the host 400 and the printer 420 via a network (not shown). Data is input to or output from the server 410 via the network.

The first network interface unit 400-4 transmits the data encrypted by the encryption unit 400-3 to the storage unit 420-2 of the printer 420. The first network interface unit 400-4 will be referred to as a transmission unit in the accompanying claims.

The display unit 400-5 displays the print operation ID, which has been used to encrypt the data.

The second network interface unit 420-1 of the printer 420 receives the encrypted data from the first network interface unit 400-4 and receives the unique key from the server 410 in response to a request for the unique key issued by the printer 420.

The storage unit 420-2 stores the encrypted data received by the second network interface unit 420-1. The storage unit 420-2 stores various encrypted data and the respective print operation IDs as files.

The key input unit 420-3 receives key signals and a print operation ID input by the user. The print operation ID input by the user is the same as the print operation ID displayed by the display unit 400-5.

The searching unit 420-4 searches the storage unit 420-2 for data corresponding to the print operation ID input by the user. Thereafter, the searching unit 420-4 issues a request for a unique key to the server 410 via the second network interface unit 420-1 in order to interpret a password of the data retrieved from the search. The server 410 transmits the unique key requested by the searching unit 420-4 to the searching unit 420-4 via the second network interface unit 420-1.

The decryption unit 420-5 decrypts the searched data by using the unique key received from the searching unit 420-4.

The image conversion unit 420-6 converts the decrypted data transmitted from the decryption unit 420-5 into an image.

The print engine 420-7 prints the image transmitted from the image conversion unit 420-6.

The image conversion unit 420-6 and the print engine 420-7 will be referred to as a conversion and output unit in the following claims.

FIG. 5 is a flowchart of a printing method that supports a security function according to another embodiment of the present invention. Referring to FIGS. 4 and 5, in operation 500, a print operation is performed when the host 400 receives a print command from a user while performing an application program.

When the host 400 receives the print command from the user, the key generation unit 400-2 of the host 400 generates a print operation ID and a unique as encryption keys in operation 510. Here, the print operation ID is an ID of a print operation, which is generated in response to the receipt of the print command, and the unique key is preferably an arbitrary set of characters.

In operation 520, the encryption unit 400-3 encrypts data by using the print operation ID and the unique key generated by the key generation unit 400-2.

In operation 530, the encrypted data is transmitted to the storage unit 420-2 of the printer 420 via the first network interface unit 400-4 and then stored therein, the print operation ID and the unique key are transmitted to the server 410 via the display unit 400-5 and then stored therein, and the print operation ID is displayed by the display unit 400-5.

In operation 540, the user inputs the same print operation ID as the one displayed by the display unit 400-5 by using the key input unit 420-3.

In operation 550, the searching unit 420-4 receives the print operation ID input by the user and searches the storage unit 400-2 for data corresponding to the print operation ID input by the user.

In operation 560, the searching unit 420-4 issues a request for a unique key to the server 410 via the second network interface unit 420-1 and then receives the unique key from the server 410.

In operation 570, the decryption unit 420-5 decrypts the searched data by using the unique key received from the searching unit 420-4 and then transmits the decrypted data to the image conversion unit 420-6.

In operation 580, the image conversion unit 420-6 converts the decrypted data into an image, and the print engine 420-7 prints the image received from the image conversion unit 420-6.

As described above, according to embodiments of the present invention, it is possible to protect data to be printed by generating encryption keys and encrypting the data to be printed by using the encryption keys whenever a host receives a request for printing the data to be printed. Even when a printer is shared by many people, it is possible to guarantee the security of the data to be printed without concern about unauthorized disclosure of confidential information.

Since in the present invention, the data to be printed is encrypted by using the encryption keys generated by the host, the data to be printed cannot be printed without the encryption keys. Thus, even if the data to be printed is intercepted by an unauthorized person, the unauthorized person cannot print the document if he/she does not have the encryption keys.

In addition, in the embodiments of the present invention, the data to be printed can be printed only when a user who issues a print command comes over to a printer and then connects his/her movable storage medium to the printer. Therefore, it is possible to prevent the data to be printed from being intercepted by an unauthorized person. Moreover, the data to be printed is not stored in the user's movable storage medium. Thus, even when the user's movable storage medium accidentally falls into another person's possession, an unauthorized disclosure of the data to be printed can be prevented.

In the case of printing the data to be printed using a predetermined server via a network, the predetermined server only receives encryption keys. Thus, even when the encryption keys are intercepted by an unauthorized person, it is possible to prevent the data to be printed from being obtained by an unauthorized person.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A printing system that supports a security function, comprising:
a host, which encrypts data that is to be printed by using encryption keys when a print command is received;
a movable storage medium, which is connected to the host and stores the encryption keys; and
a printer, which is connected to the movable storage medium, decrypts the encrypted data transmitted from the host by using the encryption keys stored in the movable storage medium, and prints the decrypted data.

2. The printing system of claim 1, wherein the encryption keys are a print operation ID and a unique key generated by the host in response to the receipt of the print command.

3. The printing system of claim 2, wherein the host comprises:
a key generation unit, which generates the print operation ID and the unique key in response to the receipt of the print command;
an encryption unit, which encrypts the data by using the print operation ID and the unique key; and
a transmission unit, which transmits the encrypted data to the printer and transmits the print operation ID and the unique key to the movable storage medium.

4. The printing system of claim 2, wherein the printer comprises:
a searching unit, which receives the print operation ID and the unique key from the movable storage medium and searches various encrypted data that have been received from the host for data corresponding to the print operation ID;
a decryption unit, which decrypts the data retrieved by the searching unit by using the unique key received by the searching unit; and
a conversion and output unit, which converts the decrypted data into an image and then outputs the image.

5. The printing system of claim 4, wherein the printer further comprises a storage unit, which stores the various encrypted data that has been received from the host.

6. A printing method that supports a security function, comprising the steps of:
(a) encrypting data that is to be printed by using encryption keys when a print command is received;
(b) transmitting the encrypted data to a printer and transmitting the encryption keys to a movable storage medium; and
(c) decrypting the encrypted data by using the encryption keys stored in the movable storage medium and then printing the decrypted data.

7. The printing method of claim 6, wherein the encryption keys are a print operation ID and a unique key generated by the host in response to the receipt of the print command.

8. The printing method of claim 7, wherein step (a) further comprises the steps of:
(a-1) generating the print operation ID and the unique key when the print command is received; and
(a-2) encrypting the data by using the print operation ID and the unique key.

9. The printing method of claim 7, wherein step (c) further comprises the steps of:
(c-1) searching various encrypted data that have been received from the host for data corresponding to the print operation ID stored in the movable storage medium;
(c-2) decrypting the retrieved data by using the unique key stored in the movable storage medium; and
(c-3) converting the decrypted data into an image and then printing the image.

10. A printing system that supports a security function, comprising:
a host, which encrypts data that is to be printed by using a print operation ID and a unique key when a print command is received;
a server, which receives the print operation ID and the unique key from the host via a network and then stores and outputs the print operation ID and the unique key; and
a printer, which searches various encrypted data that has been received from the host for data corresponding to a print operation ID input by a user, issues a request for a unique key for the retrieved data to the server, decrypts the retrieved data with the unique key received from the server, and outputs the decrypted data.

11. The printing system of claim 10, wherein the host comprises:
a key generation unit, which generates the print operation ID and the unique key in response to the receipt of the print command;
an encryption unit, which encrypts the data by using the print operation ID and the unique key and transmits the print operation ID and the unique key to the server;
a display unit, which displays the print operation ID; and
a transmission unit, which transmits the encrypted data to the printer.

12. The printing system of claim 10, wherein the printer comprises:
an input unit, which allows the user to input the same print operation ID as the print operation ID displayed by the display unit;
a searching unit, which searches the various encrypted data that have been received from the host for the data corresponding to the print operation ID, issues a request for the unique key for the searched data to the server, and receives the unique key for the searched data;
a decryption unit, which decrypts the data retrieved by the searching unit by using the unique key received by the searching unit; and
a conversion and output unit, which converts the decrypted data into an image and outputs the image.

13. The printing system of claim 12, wherein the printer further comprises a storage unit, which stores the various encrypted data that have been received from the host.

14. A printing method that supports a security function comprising:
(a) encrypting data that is to be printed by using a print operation ID and a unique key when a print command is received;
(b) transmitting the encrypted data to the printer and transmitting the print operation ID and the unique key to a server via a network; and
(c) decrypting data corresponding to an input print operation ID by using the unique key stored in the server and then outputting the decrypted data.

15. The printing method of claim 14, wherein step (a) further comprises the steps of:
(a-1) generating the print operation ID and the unique key in response to the receipt of the print command;
(a-2) encrypting the data by using the print operation ID and the unique key; and
(a-3) displaying the print operation ID.

16. The printing method of claim 14, wherein step (c) further comprises the steps of:
(c-1) allowing the user to input the same print operation ID as the print operation ID displayed in (a-3);
(c-2) searching the various encrypted data that have been received from the host for the data corresponding to the print operation ID;
(c-3) issuing a request for the unique key for the retrieved data to the server and receiving the unique key for the retrieved data;
(c-4) decrypting the data retrieved by the searching unit by using the unique key received in (c-3); and
(c-5) converting the decrypted data into an image and outputting the image.
